(19) United States
(12) Patent Application Publication
(10) Pub. No.: US 2006/0272522 A1
(43) Pub. Date: Dec. 7, 2006

(54) Printing press and method for operating a printing press

(76) Inventors: Werner Agne, Rothenbach (DE); Jochen Schlinkert, Hochstadt/Aisch (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/554,034

(22) PCT Filed: Mar. 23, 2004
(86) PCT No.: PCT/EP04/03072

§ 371 Date: Aug. 8, 2006

(30) Foreign Application Priority Data
Apr. 22, 2003 (DE) 103 18 209.8

(51) Int. Cl. B41F 5/18

(52) U.S. Cl. 101/180

(57) ABSTRACT

The invention relates to a printing press and a method for operating a printing press comprising at least one print unit, a drive unit that is assigned to the print unit, a control unit at least for regulating a drive unit, and a print mark measuring device, register measuring device, or register mark measuring devices. The print mark measuring device, or the register measuring device is directly connected to the control unit provided at least for regulating a drive unit by means of a signal transmission means. The print mark measuring device directly transmits a print mark signal to the control unit, the control unit calculating a correction factor for regulating the movement of at least one drive unit such that the printing quality is improved.

### CROSS REFERENCE TO RELATED APPLICATIONS

This application is the US National Stage of International Application No. PCT/EP2004/003072, filed Mar. 23, 2004 and claims the benefit thereof. The International Application claims the benefits of German application No. 10318209.8, filed Apr. 22, 2003, both applications are incorporated by reference herein in their entirety.

### FIELD OF INVENTION

The invention relates to a printing press or to a method for operating a printing press, as well as to a control unit for regulating a drive unit of the printing press.

### SUMMARY OF THE INVENTION

Application DE 197 23 059 A1 discloses a cylinder printing press as an example of a printing press. With this type of cylinder printing press register controllers are used for accurate baseline alignment of a print cylinder pressing on a side of a track. Register deviations picked up are fed to an input of the register controller by a sensor which is assigned to one side of the track. Via a further input the register controller is connected to a bus of a higher-ranking controller. The higher-ranking controller comprises a control console, section computer and service interfaces accessible via modems. The required values for regulation of drive motors are provided by the higher-ranking controller. In application DE 197 23 059 A1 it is especially pointed out that a color register does not move outside a tolerance area. The speed of the color register regulation is of particular importance. The faster the registration is regulated the more advantageous this is. In the sense of minimizing the error delay time it is proposed to arrange a sensor immediately behind each print position.

From the cost consideration standpoint however it is pointed out that it is sufficient to provide just one sensor per track side and to place this sensor as close as possible behind the last print position which is to be adjusted for correct baseline alignment to a reference color.

For register regulation register marks are printed for example by print cylinders on the track which are recorded by means of pair of sensors arranged beyond the last print unit. The register marks printed on the track are picked up by sensors and evaluated in a measurement head of the sensor. The register discrepancies between the print cylinders and a reference cylinder determined are fed from an output of the sensor to an input of the register regulator.

Register marks are thus printed markings which are also known as print marks and which can be employed for optimizing printing.

The object of the present invention is to achieve a low-cost or an improved faster processing of signals of a color register regulation, i.e. in general of a register regulation or a print mark which is picked up by a sensor, a print mark scanner. A further object is to achieve an improved error correction.

This object is successfully achieved by the claims. The dependent claims are advantageous, non-self-evident embodiments of the invention.

One embodiment of the printing press is for example an individual print unit. A further embodiment of the printing press is for example a printing press with two or more print units. The print units are advantageously harmonized with one another.

An inventive printing press features at least one print unit, a drive unit which is assigned to the print unit, a control unit for at least regulating a drive unit and a print mark measuring device and/or register measuring device. The print mark measuring device or the register measuring device is directly connected by a means for signal transmission to the control unit, which is at least provided for regulating a drive unit. The direct connection reduces the signal path, i.e. the signal delay time, by comparison with the patent application mentioned above. In this way it is possible to react more quickly and better to discrepancies in the print image.

The register measuring device for example features a CCD camera or a scanning device. Optical signals picked up by the register measuring device allow the baseline alignment of the printer to be determined. For color printing this involves color registers also known as registration marks—or accordingly a color register measuring device. A color register measuring device can be used both for print marks and also for printing without print marks using the print itself.

The printing press for example features a large number of printing mechanisms which, to produce a good print image, have to rotate very accurately synchronously and correctly positioned in relation to one another. To check this print marks are made on the paper to be printed for example. For evaluation of these print marks at least one print mark measuring device—also know as a measuring scanner—is provided. With the aid of the print mark measuring device the difference between the individual print mechanisms or colors is measured. This type of difference can also be determined by evaluating the print image with the aid of a (color) register measuring device and a corresponding evaluation unit. At this point and below a print mark is also to be taken, alternatively or in combination, to mean a registration mark. The print mark measuring device is then to be understood as a register mark measuring device which is used as an alternative to or in combination with the print mark measuring device. The register mark measuring device is intended for detection of the register marks. For the use of the improved print mark measuring device or register mark measuring device a high-resolution image analysis device is in this case especially of advantage. The measurement of the difference is used for determination of at least one correction factor for a scope register of the print mechanisms or color lying outside the tolerance for example. These correction factors are time-critical and the precise control of these correction factors is very important for the quality of the print image. The print mark measuring device or the register measuring device is connected directly to a control unit for drive regulation of a drive of the printing press. A means for signal transmission such as transmission over a cable or also radio transmission can be used for the connection. A direct connection of this type results in fast processing of the correction factor which is calculated in the control unit for example, and thus in an improvement in the print image quality as well.

By contrast, in application DE 197 23 059 A1 the signal of the sensor is transferred to an assigned register controller, with the register controller being connected by a bus to a higher-ranking control and a correction factor for improving the baseline alignment being able to be transferred corrected via the control console to a drive controller as a required value of the higher-ranking controller.

This long chain of communication partners is now shortened in accordance with the invention by the print mark measuring device being connected by a means for signal transmission to the control unit, which is at least intended for regulating one drive.

In an advantageous embodiment of the invention the print mark measuring device evaluates the measurement signal of the print mark measuring device or the register measuring device in an evaluation unit. The evaluation unit of the print mark measuring device has a direct data connection for example via a serial connection to the control unit, that is a drive control of the print mechanism. In the control unit software can be executed which evaluates the measured values of the print mark measuring device and calculates the correction factors or also implements the correction directly.

Through the direct connection and thereby faster processing of the correction factors a qualitative improvement of the print image is produced. Further a cost saving results from the omission of the previously required separate correction processor. The correction signal or the correction signals are for example sent via an existing communication connection within a printing press from the control unit to a control console.

The print mark measuring device which features an evaluation unit, with the evaluation unit converting the signals generated by a print mark measuring device into digital signals are example, sends these digital signals for example via a bus system to the control unit. A bus system which is already employed in the printing press can advantageously be used as a means for signal transmission. The same procedure can be used for a register measuring device.

In a further advantageous embodiment the control unit features the integrated evaluation unit which converts a signal generated by the print mark measuring device or the register measuring device, e.g. an analog signal, into a digital signal that can be processed by the control unit.

In a further advantageous embodiment the control unit, which is at least provided for regulation one drive unit and is directly connected to the print mark measuring device or the register measuring device, has a master functionality in respect of further drive units or in respect of further control units. A drive unit in this case features at least one electric motor and a power converter.

The desired object is also successfully achieved by a control unit for regulating a drive unit of a printing press, with the control unit featuring a signal interface for entry of a signal of a print mark measuring device or a register measuring device.

In a method for operating a printing press the print mark measuring device transfers a print mark signal or the register measuring device transfers a register measuring signal to the control unit. A correction factor for regulating the movement of at least one drive unit is calculated by the control unit.

Exemplary embodiments of the invention are shown in the drawing and are explained in greater detail below.

### BRIEF DESCRIPTION OF THE DRAWINGS

FIG. 1 shows a printing press,

FIG. 2 shows a further printing press,

FIG. 3 shows the communication between of a print mark measuring device and a drive unit with assigned control device, and

FIG. 4 shows the signal path of a print mark signal.

### DETAILED DESCRIPTION OF INVENTION

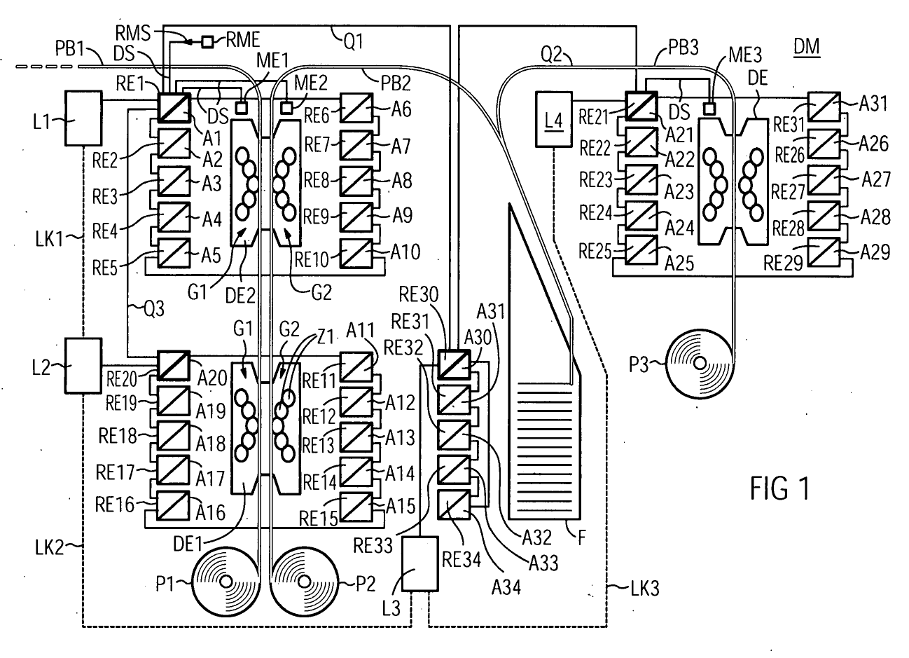

In the drawing in FIG. 1 the layout of a printing press DM is shown in the form of an overview diagram. From paper rollers P1 to P3 paper tracks PB1 to PB23 pass through print units DE, DE1 and DE2 as well as to a folder unit F.

The paper track PB1, after passing through the print units DE1 and DE2, arrives at further processing units which are not however shown in the drawing in accordance with FIG. 1. The paper track PB1 thus leaves the system in the drawings where indicated by the dashed line.

The print units DE, DE1 and DE2 are shown in the drawing by an approximately H-shaped exterior contour. In the print units DE, DE1 and DE2 There are 10 of cylinders ZY in each case arranged into two groups G1, G2 of five cylinders ZY each. Cylinders ZY are here taken to mean all cylinders or wheel-shaped machine elements of a print unit DE, DE1 DE2 as well as of a folder unit F. The paper tracks PB1 to PB3 run over these groups G1, G2 which are known as print locations in the print units DE.

A print location consists essentially for example of a rubber cylinder, a plate cylinder and a color or damping mechanism. With each print location a color can be printed on a page. All print locations which operate on a folder unit F, i.e. for which the printed paper tracks PB1 to PB3 are fed to a folder unit F belong to one rotation. In this case the print units DE, DE1, DE2 are usually accommodated in print turrets.

A drive unit A1 to A29 belongs to each individual driven cylinder. The drive unit A1 to A29 is assigned a control unit RE1 to RE29. Depending on the degree of integration for the drive units a drive unit typically contains a motor and a power converter. In a higher level of integration the drive unit features an integrated control unit RE1 to RE29. Drive units A30 to A34 or associated control units RE30 to RE34 are also provided for the folder unit F. The print units DE, DE1 and DE2 or the folder unit F feature for each drive group which features the drive units, one control unit RE1, RE20, RE21 and RE30 with master functionality. The control units RE1 to RE10 of a drive group are networked with each other by data connections. The control units RE1, RE20, RE21 and RE33 or the drive units A1, A20, A21 and A30, which have a control or master functionality, are identified in the drawings by a bolder outline around the unit.

A group of drive units or control units is assigned to an associated control computer L1 to L4 and have data connections to this computer. The control computers L1 to L4 are also interconnected by control computer communication LK1 to LK3. This is shown in the drawing by a dotted line. Here too further embodiments of the data networking is possible.

A control computer L1 to L4 takes over a higher-ranking process organization. At the end of the print units DE and DE2 a print mark measuring device ME1, ME2 and ME3 is arranged, which is used to pick up print marks of the paper tracks PB1, PB2 and PB23. The print mark measuring device ME1, ME2 and ME3 is connected to a control unit RE1 or RE21. The control unit RE1 or RE21 determines the correction factor for the drive unit or the drive units to improve the print image. This gets around the procedure that was previously needed where the correction factor was calculated by a separate evaluation electronics and output for example by a pulse-width modulated binary signal to the relevant drive units of the print mechanisms. A long path which was previously required as regards the transmission of the correction factors to a control computer of the printing press e.g. via a serial connection, by Profibus® or Arcnet, is no longer necessary.

By linking the print mark measuring device ME1, ME2, ME3, e.g. by a serial data connection (DS) directly to the control unit RE1, RE21 or the drive controller of the print mechanism, the signal path is significantly shortened which benefits faster evaluation of the signals or correction. Direct linkage and thereby fast processing of these correction factors produces an improvement in print image quality. The omission of a separate correction computer also produces cost optimization. The correction signals are transmitted via existing communication connections of the control units to a control computer or to a control console.

For the paper track PB1 a register measuring device RME is provided as an alternative to or in combination with the print mark measuring device ME1, said device having a data connection to the control unit RE1. A register measuring signal RMS, shown in FIG. 1 as an arrow is then used for correction of the print.

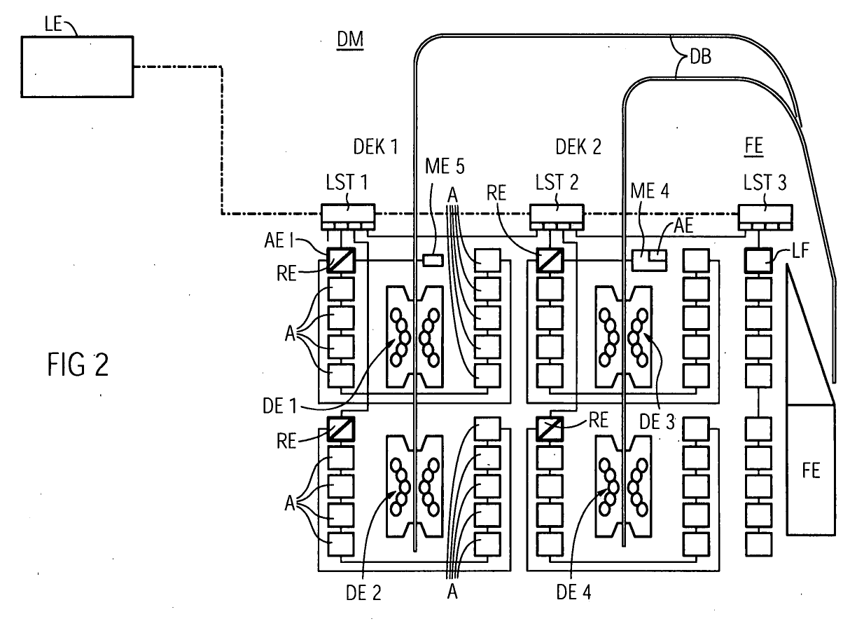

The diagram in FIG. 2 shows a printing press DM in which print tracks DB run which can be folded in a folder unit F. The print mark measuring device ME5 serves as a sensor for the print marks on the print tracks and transmits the sensor data to an integrated evaluation unit of the control unit RE. The control units RE are linked to various drive units A of a print unit DE1, DE2, DE3 and DE4.

The print mark measuring device ME4 features an evaluation unit AE, with the print mark signal able to be transmitted to the control unit RE via a bus connection The control units RE have data connections to the control computers LST1, LST2 and LST3. The control consoles LST1, LST2 and LST3 have data connections to a control unit LE.

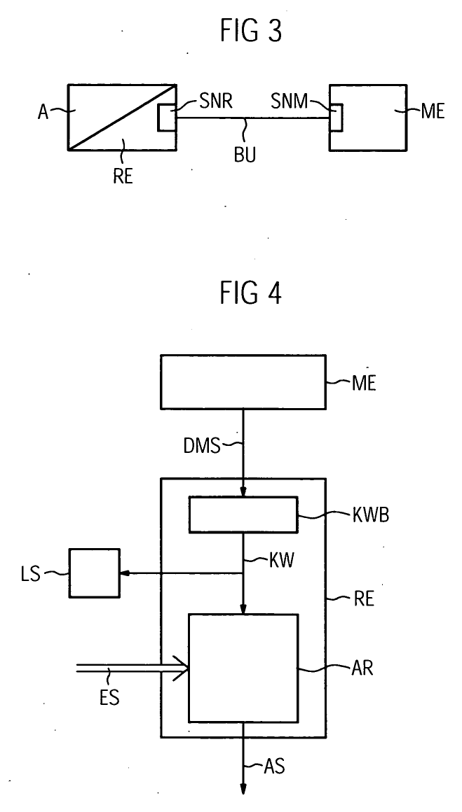

The diagram in FIG. 3 shows the data connections between a print mark measuring device ME and a drive unit A, to which a control unit RE is assigned. The control unit has an interface SNR and the print mark measuring device an interface SNM. The connection is made by means of a bus cable BK. Depending on the degree of integration the control unit is integrated into the drive unit for example, so that in the drive unit controls such as current regulation and other controls such as torque regulation or speed regulation are undertaken.

The diagram in FIG. 4 shows the signal path of a print mark signal DMS. A print mark signal DMS is generated by the print mark measuring device ME and is transmitted to a control unit RE. In the control unit a correction factor calculation MB is undertaken which outputs a correction factor KW. This correction factor KW serves as input signal for a drive control AR, with the drive control AR having further input signals available to it. The corrected output signal AS is then used for more precise regulating of the drives, so that an improvement in print quality can be achieved. The correction factor KW can additionally be output to a control console LS.

1.-10. (canceled)

11. A printing press, comprising:
a print unit;
a drive unit assigned to the print unit;
a control unit for regulating the drive unit; and
a print mark measuring device and/or register mark measuring device and/or a register measuring device, wherein the print mark measuring device and/or the register mark measuring device and/or the register measuring device are directly connected to the control unit.

12. The printing press in accordance with claim 11, wherein the print mark measuring device and/or the register mark measuring device and/or the register measuring device are connected by a means for signal transmission to the control unit.

13. The printing press in accordance with claim 11, wherein the print mark measuring device and/or the register mark measuring device and/or the register measuring device comprises an evaluation unit.

14. The printing press in accordance with claim 11, wherein the control unit comprises an integrated evaluation unit.

15. The printing press in accordance with claim 11, wherein a correction factor can be calculated by the control unit to regulate the movement of the drive unit.

16. The printing press in accordance with claim 13, wherein a correction factor can be calculated by the control unit to regulate the movement of the drive unit.

17. The printing press in accordance with claim 14, wherein a correction factor can be calculated by the control unit to regulate the movement of the drive unit.

18. The printing press in accordance with claim 11, wherein the print mark measuring device and/or the register mark measuring device and/or the register measuring device are connected to the control unit by a field bus system or a serial link.

19. The printing press in accordance with claim 13, wherein the print mark measuring device and/or the register mark measuring device and/or the register measuring device are connected to the control unit by a field bus system or a serial link.

20. The printing press in accordance with claim 14, wherein the print mark measuring device and/or the register mark measuring device and/or the register measuring device are connected to the control unit by a field bus system or a serial link.

21. The printing press in accordance with claim 15, wherein the print mark measuring device and/or the register mark measuring device and/or the register measuring device are connected to the control unit by a field bus system or a serial link.

22. The printing press in accordance with claim 12, wherein a field bus system or a serial link is provided as means for signal transmission.

23. The printing press in accordance with claim 11, wherein the control unit has a master functionality with regard to further drive units or with regard to further control units.

24. The printing press in accordance with claim 13, wherein the control unit has a master functionality with regard to further drive units or with regard to further control units.

25. The printing press in accordance with claim 14, wherein the control unit has a master functionality with regard to further drive units or with regard to further control units.

26. The printing press in accordance with claim 15, wherein the control unit has a master functionality with regard to further drive units or with regard to further control units.

27. A control unit for regulating a drive unit of a printing press in accordance with claim 11, wherein the control unit comprises a signal interface for input of a signal of a print mark measuring device and/or a register mark measuring device and/or of a register measuring device.

28. The control unit in accordance with claim 27, wherein the control unit is provided for determining a correction, factor from the signal of the print mark measuring device and/or register mark measuring device or the signal of a register measuring device for regulating the movement of at least one drive unit.

29. A method for operation of a printing press, the printing press comprising:
a print unit;
a drive unit assigned to the print unit;
a control unit for regulating the drive unit; and
a print mark measuring device and/or register mark measuring device and/or a register measuring device, wherein the print mark measuring device and/or the register mark measuring device and/or the register measuring device are directly connected to the control unit, the method comprising:
transmitting a print mark signal and/or the register mark signal from the print mark measuring device and/or the register mark measuring device to the control unit, or transmitting a register measuring signal from the register measuring device to the control unit.

30. The method in accordance with claim 29, wherein a correction factor for regulating the movement of at least one drive unit is calculated by the control unit from the print mark signal or from the register mark signal or from the register measuring signal.
